(19) United States
(12) Patent Application Publication
(10) Pub. No.: US 2009/0200421 A1
(43) Pub. Date: Aug. 13, 2009

(54) EFFICIENT AIRPORT RUNWAY MANAGEMENT SYSTEM

(76) Inventor: Vinayak Virkar, Pune (IN)

Correspondence Address: Vinayak Virkar, 73, Satyaki Bungalow, Lane No. 6, Dahanukar Colony, Pune, 411038, omitted

(21) Appl. No.: 12/307,366

(22) PCT Filed: Jul. 30, 2007
(86) PCT No.: PCT/IN2007/000322

§ 371 Date: Jan. 5, 2009

(30) Foreign Application Priority Data
Aug. 8, 2006 (IN) 1250/MUM/2006

(51) Int. Cl. B64F 1/00

(52) U.S. Cl. 244/114 R

(57) ABSTRACT

The present invention relates to the introduction of inclined runways with a desirable and specified slope to considerably reduce aircraft landing time and also the runway length. The present invention also relates to the introduction of inclined or sloping runways to considerably reduce aircraft take-off time and airport runway length.

### FIELD OF THE INVENTION

The present invention relates to an efficient airport runway management system.

More particularly, the present invention relates to the introduction of inclined runways, i.e. with a desirable and specified slope, to considerably reduce aircraft landing time and also the runway length.

The present invention also relates to introduction of inclined or sloping runways to considerably reduce aircraft take-off time and airport runway length.

The present invention also relates to introduction of multiple entries and exits for single sloping runway or for multiple sloping runways to reduce take-off and landing time.

The present invention further relates to introduction of multi story terminal and gates with multiple inclined and declined or sloping downwards runways, exits and entries for various types of aircrafts.

### PRIOR ART

In prior art most of the airports are using a single runway for aircraft landing and take off for various types of aircrafts. There is provided a second runway is used but the same is used only as a stand by or in case of emergency.

Small, medium, large, and extra large aircrafts have to use only one runway for landing and take-offs irrespective of their size or requirement. Most of the small and medium airplanes do not require large runway, hence using long runway for small airplanes consumes more landing and take-off time, space and unnecessary wastage of fuel.

In U.S. Pat. No. 6,927,701 Techniques are described for monitoring runway occupancy and providing an indication of occupancy of a runway to an airplane on final approach the runway. A system, for example, defines and monitors one or more zones on the runway to determine whether the runway is occupied. Such a system includes sensors, such as inductive loop sensors, that may be located proximate to or on the runway, and the system may monitor ingress and egress of objects, such as airplanes or other vehicles on the ground, into and out of the zone in order to determine whether the zone is activated. The sensors may be located at points of entry and exit for the zone. The zones may be located at take-off hold areas of the runway and intersections of the runway with taxiways. A ground-based approach light array of the system may provide the indication of runway occupancy to the airplane. This patent does not focus on multiple runaways for different types of aircraft or optimum space utilization.

U.S. Pat. No. 6,978,205 provide a solution to the problem of overrunning of the aircraft. A critical point on a runway indicates a point at which an aircraft may experience a runway overrun if landing beyond the critical point. A path projection is extended from the aircraft at a descent slope angle to determine whether the aircraft will land beyond the critical point at the current descent slope. Timely alerts may be provided by accounting for the time required to announce a distance value, and the distance traveled during the announcement. But again this is entirely different from the present invention.

In U.S. Pat. No. 6,969,213 provides a roadway upon which a vehicle travels and on which the vehicle is decelerated. The roadway includes: a movable surface extending in a direction of the vehicle's travel; and a potential energy storage mechanism operatively connected to the movable surface for converting a kinetic energy of the vehicle into potential energy upon movement of the movable surface thereby slowing the vehicle. Also provided is a roadway upon which a wheeled vehicle travels in which the vehicle is accelerated. The roadway includes: a movable surface extending in a direction of the vehicle's travel; and a potential energy transfer mechanism operatively connected to the movable surface for transferring a stored potential energy associated with the movable surface into kinetic energy upon movement of the movable surface thereby propelling the vehicle. This patent focuses only on deceleration of a vehicle and thus is entirely different from the present invention.

### THE DEFICIENCIES OR DRAWBACKS IN THE EXISTING ART

1. The landing time is higher.
2. The take-off time is also higher.
3. Aircraft jams are caused as aircrafts have to encircle around the airport for landing. This happens due to single runaway system.
4. Airport traffic jams are also caused as aircrafts have to wait in line for take-off.
5. Inconvenience to passengers due to traffic jams.
6. Missing of connecting flights
7. Cancellation of flights.
8. Passengers have to go to other airports.
9. Wastage of aircraft fuel.
10. Space requirement is considerably high.
11. Safety is considerably less.

Therefore, it is the object of the present invention to reduce runway length and thereby the landing time leading to reduction in Airport traffic jams.

It is the object of the present invention to provide an efficient landing and takeoff system by utilizing very less space thereby resulting in optimum space utilization.

It is the object of the present invention to provide an efficient landing and takeoff system in areas with space constraints thereby resulting in more number of airports. This would lead to consumer convenience and satisfaction.

It is the object of the present invention to reduce aircraft fuel cost.

It is also an object of the present invention o reduce the accidents.

Yet another object of the present invention to increase aircraft frequency, aircraft safety, and optimum space utilization and to increase airport efficiency and business by introduction of inclined and declined or downward/upward sloping runways, multiple runways, multiple entries, multiple exits and multi story terminals and gates.

It is thus the object of the present invention to provide runways which are aircraft specific, i.e. designed as per the size and requirement of the aircraft.

### DESCRIPTION OF THE INVENTION

The foregoing objects of the invention are accomplished and the problems and shortcomings associated with prior art techniques and approaches are overcome by the present invention described in the preferred embodiment. The present invention will now be described with reference to the accompanying drawings wherein:

FIG. 1: Shows the front view of the landing position of single inclined runway.

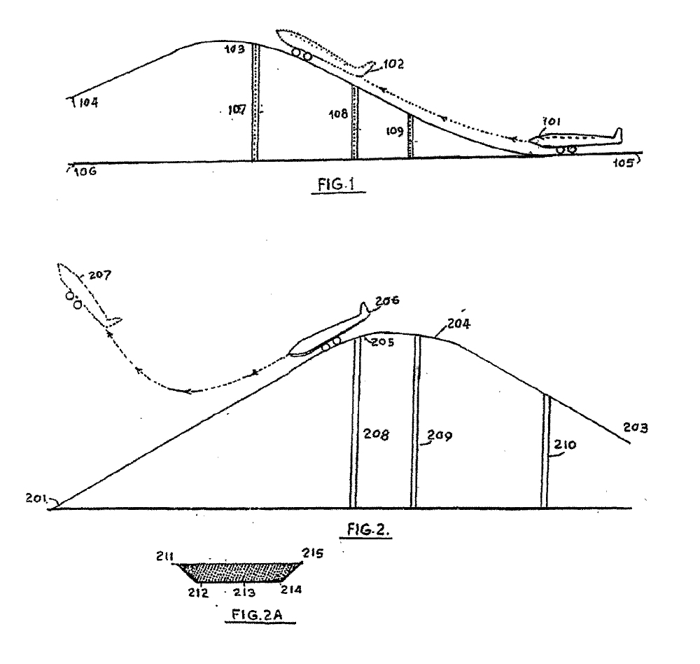

FIG. 2: Shows the front view of the take-off position of single declined runway.

FIG. 2A: Shows the cross sectional view of runway.

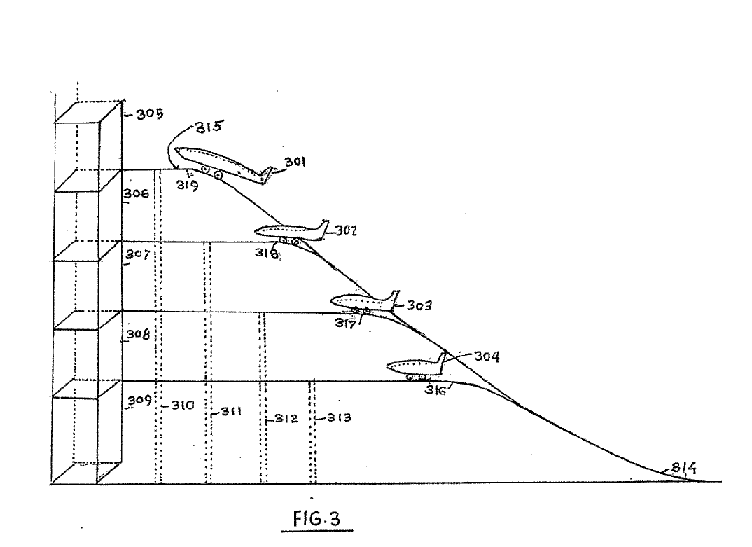

FIG. 3: Shows the front view of the landing position of single inclined runway with multiple exits and multi story terminals.

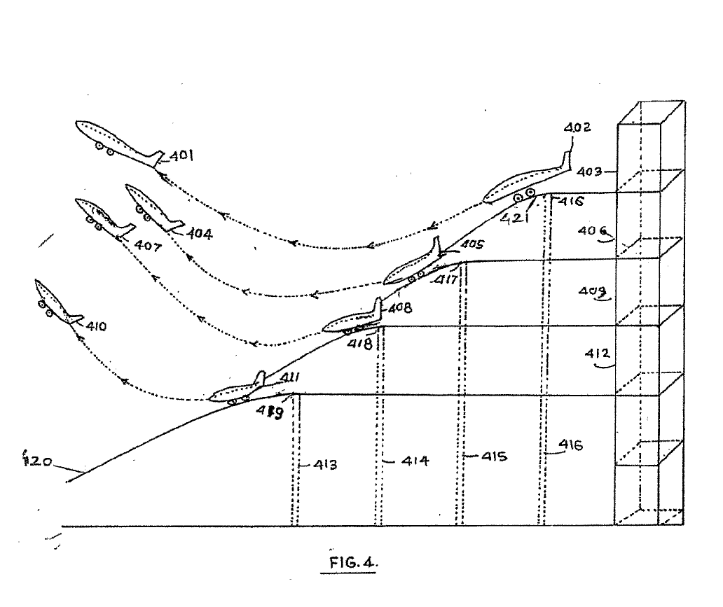

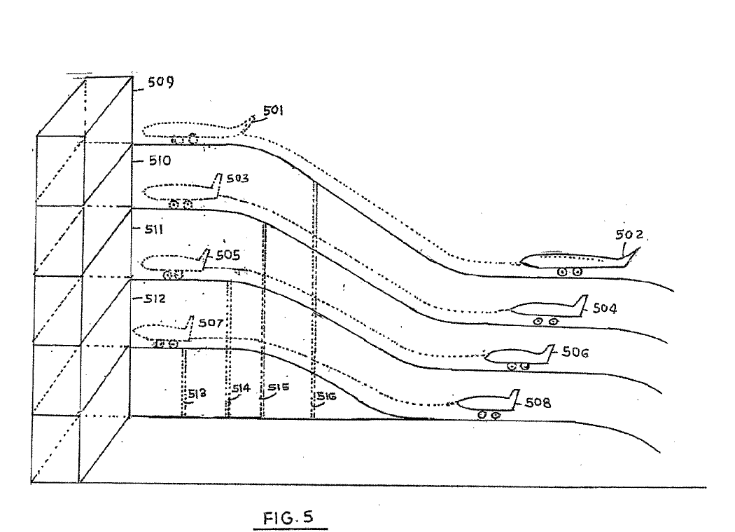

FIG. 4: Shows the front view of the take-off position of single declined runway with multiple entries from multi story terminals.

FIG. 5: Shows the front view of the landing position of inclined multiple runways parallel to each other, for different kind of planes.

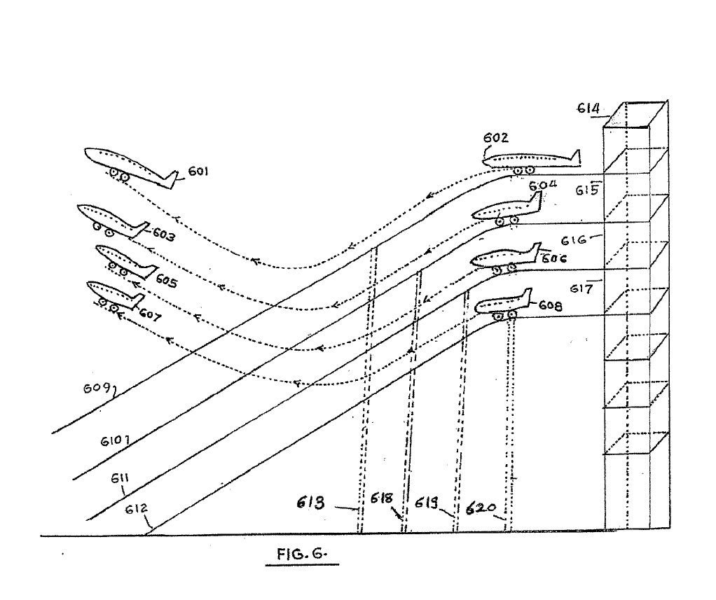

FIG. 6: Shows the front view of the take off position of declined multiple Runways parallel to each other for different kind of planes.

The present invention is now described in detail with reference to the above mentioned figures.

FIG. 1: Shows the view of a single inclined runway used for landing an aircraft. The said inclined, i.e. upward sloped runway helps to curb the speed of the landing aircraft as it moves in the opposite direction of gravity. The angle of inclination would depend upon the type and specifications of the landing aircraft. Therefore the aircraft (101) starts landing on inclined runway (103 to 105), aircraft will be decelerated. There is also provided an exit way (103 to 104). Ground level is denoted by (105-106). Structural columns of the inclined runway are denoted by 107, 108 and 109.

FIG. 2: Shows the view of a single declined or downward sloping runway used for the take-off of an aircraft. The aircraft would start from the flat portion as shown on the runway and proceed downwards. Moving in the direction of the gravitational force helps to gather the requisite faster momentum and thus it will take-off as shown. Therefore 203 to 204 is the entry from terminal to runway. The declined or downward sloping runway is denoted by 205-201. The take off of the aircraft is shown by a continuous motion of the aircraft in the path of 206 to 207. Structured columns of the declined runway are denoted by 208, 209 and 210.

FIG. 2A: Shows the cross sectional view of runway. The runway has a safety wall or railing on both sides of the runway. This safety wall or railing is built at a specified angle as shown depending upon the specifications of the aircraft. This railing prevents the off tracking of the aircraft. 212 to 214 denote the width of the runway. The center of the runway is denoted by 213. Left railing or safety wall is denoted by 211-212 and the right railing is denoted by 214-215.

FIG. 3: Shows the front view of a single inclined runway with multiple exits and multi story terminals used for landing an aircraft. The landed aircraft would exit from the specified terminal depending upon the specifications of the aircraft. Thus a bigger aircraft would require a more inclined runway and thus exit at a higher terminal.
301—Extra large aircraft landing position.
302—Large aircraft landing position.
303—Medium aircraft landing position.
304—Small aircraft landing position.
305—Fifth floor terminal
306—Fourth floor terminal
307—Third floor terminal
308—Second floor terminal
309—Ground or first level.
310, 311, 312 and 313—Inclined runway columns.
314 to 315—Inclined runways.
316, 317, 318 319 multiple exits of a single runaway.

FIG. 4: Shows the view of a single declined runway or runway with specified downward slope used for the take off of an aircraft. The said single inclined runway is with multiple entries from multi story terminals. Depending upon the requirement of the aircraft, the runway with the requisite height would be used.
402 to 401—take-off position of extra large aircrafts
405 to 404—take off position of large aircrafts
408 to 407—take off position of medium aircrafts.
411 to 410—take off position of small aircrafts.
412—3^{rd} floor terminal.
409—4^{th} floor terminal
406—5^{th} floor terminal.
403—6^{th} floor terminal.
416, 417, 418 and 419 multiple entries of a single runaway.
420 to 421—Declined runways.

FIG. 5: Shows the view of multiple runways with multiple inclinations for different kind of planes that may be used for landing the aircrafts. The multiple runways are shown to be parallel to each other, however it is only indicative and must not be taken to be limited to the said drawing. The entries or exits may be intermingled or in the form of a mesh.
502 to 501—Landing position of extra large aircraft—going to 5^{th} floor terminal.
504 to 503—Landing position of large aircraft—going to 4^{th} floor terminal.
506 to 505—Landing position of medium aircraft—going to 3^{rd} floor terminal.
508 to 507—Landing position of small aircraft—going to 2^{nd} floor terminal.
509—Fifth floor terminal.
510—Fourth floor terminal.
511—Third floor terminal
512—Second floor terminal.

513, 514, 515 and 516—Structured columns for parallel inclined runways.

FIG. 6: Shows the view of declined or downward sloping multiple runways for different kind of planes that are used for take off of the aircraft. The multiple runways are parallel to each other.
602 to 601—Take-off position of extra large aircraft
604 to 603—Take-off position of large aircraft.
606 to 605—Take-off position of medium aircraft
608 to 607—Take-off position of small aircraft
609, 610, 611, 612—Declined or downward sloping separate runways (parallel to each other) for take-off.
614—8^{th} floor terminal.
615—7^{th} floor terminal
616—6^{th} floor terminal.
617—5^{th} floor terminal
613, 618, 619 and 620—structured columns for parallel declined runways.

Detailed descriptions of the preferred embodiment are provided herein; however, it is to be understood that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or matter.

### STATEMENT OF THE INVENTION

The present invention therefore, is an efficient airport runway management system comprising single or multiple runways with single or multiple entries and exits, the said runways being at a specified angle of inclination, the runways are parallel to each other, plurality of multi storeyed terminals and gates to facilitate aircraft landing and takeoff with optimum space utilization.

The angle of inclination of the said runways is between 15-35 degrees. This angle of inclination of each runway depends upon the type, size and weight of the aircraft.

The runway length is considerably reduced due to provision of inclination. The length of the runway depends upon the type, size and weight of the aircraft.

There is provided parking space as per the specifications of different aircrafts. This parking space is provided on all the storeys/floors.

The width of each of the said runway is different for each aircraft depending upon the specifications of each aircraft. The said runway has a railing or safety wall. There are provided separate runways for landing and separate runways for take off of the aircraft. This increases frequency and safety of aircrafts.

The embodiments of the invention as described above and the methods disclosed herein will suggest further modification and alternations to those skilled in the art. Such further modifications and alterations may be made without departing from the sprit and scope of the invention, which is defined by the scope of the following claims.

### ADVANTAGES

1. Using inclined/declined runways saves aircraft and take-off time and reduces aircraft runway length.
2. Use of inclined/declined runways reduces traffic jam.
3. Use of inclined/declined runways reduce aircraft fuel cost.
4. Increase in aircraft frequency and safety.
5. Reduced air traffic solves the problem of stranded passengers.
6. Increase in airport efficiency.

1-10. (canceled)

11. An airport, runway system comprising a first runway usable for aircraft landing, at least a portion of the first runway being upwardly sloping,
wherein a landing aircraft travels up the upwardly sloping portion of the first runway after touching ground.

12. The system of claim 11 wherein slope of the upwardly sloping portion being between 15 and 35 degrees.

13. The system of claim 11 further comprising a second runway usable for aircraft landing, at least a portion of the second runway being upwardly sloping.

14. The system of claim 13 wherein the upwardly sloping portion of the second runway and the upwardly sloping portion of the first runway share a common portion of a ramp.

15. The system of claim 13 wherein length of the upwardly sloping portion of the second runway being a part of length of the upwardly sloping portion of the first runway.

16. The system of claim 15 wherein the second runway being usable to land a second aircraft and the first runway being usable to land a first aircraft, the second aircraft being smaller than the first aircraft.

17. The system of claim 15 wherein an exit path for an aircraft is provided on the upwardly sloping portion of the first runway at termination of the upwardly sloping portion of the second runway.

18. An airport runway system comprising a runway usable for aircraft take-off, at least a portion of the runway being downwardly sloping,
wherein a taking-off aircraft travels down the downwardly sloping runway before being airborne.

19. The system of claim 18 wherein slope of the downwardly sloping portion being between 15 and 35 degrees.

20. An airport runway system comprising:
one or more runways usable for aircraft landing, at least a portion of each of the one or more landing runways being upwardly sloping; and
one or more runways usable for aircraft take-off, at least a portion of each of the one or more take-off runways being downwardly sloping.

21. The system of claim 20 wherein end point of at least one landing runway is coupled to starting point of at least one take-off runway.

22. The system of claim 21 wherein an airport terminal is positioned about coupling point between the at least one landing runway and the at least one take-off runway.

23. The system of claim 20 comprising:
a plurality of runways usable for aircraft landing, at least a. portion of each of the plurality of landing runways being upwardly sloping; and
a plurality of runways usable for aircraft take-off, at least a portion of each of the plurality of take-off runways being downwardly sloping.

24. The system of claim 23 wherein end points of the plurality of the landing runways are coupled to starting points of the plurality of the take-off runways, respectively.

25. The system of claim 24 wherein a plurality of airport terminals are positioned, respectively, at a plurality of coupling points between the landing runways and the take-off runways.

26. The system of claim 25 wherein the upwardly sloping portions of the plurality of landing runways are stacked generally one above the other.

27. The system of claim. 23 wherein the downwardly sloping portions of the plurality of take-off runways are stacked generally one above the other.

28. The system of claim 23 wherein the upwardly sloping portions of she plurality of the lauding runways are provided using a single ramp with a plurality of exit points on it.

29. The system of claim 23 wherein the plurality of runways usable for aircraft landing include at least two runways having different lengths for their sloping portions, the at least two runways being usable for landing at least two aircrafts of different sizes, respectively.

30. The system of claim 23 wherein the plurality of runways usable for aircraft take-off include at least two runways having different lengths for their sloping portions, the at least two runways being usable for taking off at least two aircrafts of different sizes, respectively.
